(19) United States
(12) Patent Application Publication
(10) Pub. No.: US 2007/0030667 A1
(43) Pub. Date: Feb. 8, 2007

(54) Reflecting member for a surface light source, production process of the reflecting member and use thereof

(76) Inventors: Takeo Watanabe, Chiba (JP); Tetsuhiko Yamaguchi, Chiba (JP); Kazuo Kimura, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/572,681

(22) PCT Filed: Sep. 14, 2004
(86) PCT No.: PCT/JP04/13723

§ 371 Date: Mar. 20, 2006

Related U.S. Application Data
(60) Provisional application No. 60/513,597, filed on Oct. 24, 2003.

(30) Foreign Application Priority Data
Sep. 19, 2003 (JP) 2003-328360

(51) Int. Cl. G09F 13/04

(52) U.S. Cl. 362/97

(57) ABSTRACT

The reflecting member for a surface light source according to the present invention is characterized by forming a white coating film on the surface of a molded metal part having a prescribed shape. According to the present invention, a reflecting member for a surface light source wherein a white coating film having sufficient reflecting properties is formed on a metal part even if a metal part having a curved part of a small curvature radius can be provided.

### CROSS REFERENCE TO RELATED APPLICATION

This application is an application filed under 35 U.S.C. §111(a) claiming benefit pursuant to 35 U.S.C. §119(e) (1) of the filing date of Provisional Application 60/513,597 filed Oct. 24, 2003 pursuant to 35 U.S.C. §111(b).

### TECHNICAL FIELD

The present invention relates to a reflecting member for a surface light source used for display devices, particularly relates to a reflecting member for a surface light source used for a reflection board of liquid crystal displays.

### BACKGROUND OF THE INVENTION

Recently, liquid crystal display screens have been employed in various devices, for example, not to mention conventionally used note type personal computers, desktop computers, liquid crystal televisions, displays of cellular phones, various kinds of video game machines, etc.

As a lighting instrument for liquid crystal display screens, edge light type lighting instruments wherein a cold-cathode tube disposed on an edge of a light-guide plate is used as a lighting source have widely been used. In this lighting method, a reflector is provided around the cold-cathode tube in order to utilize light more effectively, and further, a reflection board is provided under the light-guide plate in order to efficiently reflect light scattered from the light-guide plate to the side of the liquid crystal displace screen. The reflecting member has the above structure so that the loss of light emitted from the cold-cathode tube is decreased and the liquid crystal display screen can be brightened.

In the large-sized screen of liquid crystal display televisions, a direct type backlight method is employed because it is undesired to highly brighten the screen by the edge light method. In this method, a plurality of cold-cathode tubes are provided in parallel under the liquid crystal display screen so that the cold-cathode tubes are arranged in almost parallel on the reflection board.

Regarding the reflection boards used in the a surface light source of such a liquid crystal display screen, for example, patent literature 1 discloses an aluminum plate having a white coating film with a coating material containing titanium oxide and a polyester resin. Patent literature 2 discloses a light reflecting material having a coating film with a coating material containing barium sulfate and titanium oxide as a pigment. Patent literature 3 discloses a highly diffuse reflection coated metal plate prepared by forming a under coating layer with application of an under coating material containing a titanium oxide pigment on an aluminum plate and a top coating layer having a gloss of not more than 15 with application of a top coating material containing a titanium oxide pigment on the surface of the under coating layer.

On the reflection board formed with the above coating film, the film thickness needs to be at least 30 μm for securing the reflectance of not less than 90%, and further in order to enhance the reflectance, the film thickness is desired to be about 100 μm.

Examples of the reflection board used for the direct type backlight system may include a semi-circle reflection board 106, as shown in FIG. 3(a), wherein a curved part 104 is formed with enclosing the lower part of a cold-cathode tube 102 and a reflection board 112, as shown in FIG. 3(b), wherein both of the end parts of the reflection board are curved in the upper direction and also convex parts 112 are formed by curving the parts between the cold-cathode tubes disposed in almost parallel and thereby the curved parts 110 are formed with enclosing the lower part of each cold-cathode tube 102. Further examples thereof may include a reflection board 120, as shown in FIG. 3(c), wherein the reflection surface is plane and formed into a box shape combined with a case.

For preparing the reflection boards having such structures, it is necessary to make a special shape by subjecting a previously coated metal plate to bending processing or drawing processing. However, because the coating film is thick, there is a problem such that the coating film suffers for cracks or peeling during the processing. Furthermore, because the coating film is extended during the processing, there is also a problem caused that the thickness of the coating film is uneven partly and thereby the reflectance is varied. It is undesirable to recoat the part of the coating film in order to solve the problem because the operation efficiency is lowered and the production coat is increased.

Further, in order to overcome the above problems, it is considered that the curving radius is increased in the processing or the drawing is shallowed. However, these countermeasures induce a new problem that the designing of the shape of the reflecting member for a surface light source is limited.

In the patent literatures 2 and 3, the adhesion properties of between the metal plate and the coating film are evaluated by a cross cut peeling test with a cellophane tape. The processability is not evaluated by a bending test with a coated metal plate.

| | |
|---|---|
| Patent literature 1 | JP-A-S63(1988)-2002 |
| Patent literature 2 | JP-A-H8(1996)-160208 |
| Patent literature 3 | JP-A-2002-172735 |

### DISCLOSURE OF THE INVENTION

### OBJECT OF THE INVENTION

The present invention is intended to solve the problems associated with the prior arts, and it is an object of the invention to provide a reflecting member for a surface light source which shape is freely designed, and further has a high reflectance and can prepare a bright liquid crystal display screen. It is another object of the invention to provide a production process of the reflection member and use of the reflection member.

The present invention, furthermore, can solve the problems such that during the production process, the coating film of the reflecting member for a surface light source cracks or peels, and further the reflectance is varied by the unevenness of the film thickness of the coating film.

### Means for Solving the Subject

The present inventors have been earnestly studied and found that the present invention can solve the problems such that during the production process, the coating film of the reflecting member for a surface light source cracks or peels, and further the reflectance is varied by the unevenness of the film thickness of the coating film.

Thus, the present invention has been accomplished.

The present invention is shown below.

(1) A reflecting member for a surface light source obtainable by forming a white coating film on the surface of a molded metal parts having a prescribed shape.

(2) The reflecting member for a surface light source according to the section (1) is characterized in that the metal part comprises at least one selected from an aluminum plate, aluminum alloy plate, iron plate, stainless steel plate, copper plate, zinc steel plate and tin plate.

(3) The reflecting member for a surface light source according to the section (1) or (2) is characterized in that the white coating film has a film thickness of from 50 to 300 μm.

(4) The reflecting member for a surface light source according to any one of the sections (1) to (3) is characterized in that in the molding of the metal part, a curved part is formed on the metal part.

(5) The reflecting member for a surface light source according to the section (4) is characterized in that when the film thickness of the white coating film is A μm and the curvature radius of the curved part of the metal part is B mm, the value of A/B is not less than 10.

(6) The reflecting member for a surface light source according to any one of the sections (1) to (5) is characterized in that the white coating film comprises a powder coating material.

(7) The reflecting member for a surface light source according to any one of sections (1) to (5) is characterized in that the white coating film comprises a liquid coating material.

(8) A process of producing a reflecting member for a surface light source which process comprises the steps of molding a metal part into a prescribed shape and then forming a white coating film on the surface of the metal part.

(9) The process of producing a reflecting member for a surface light source according to the section (8) is characterized in that the metal part comprises at least one selected from an aluminum plate, aluminum alloy plate, iron plate, stainless steel plate, copper plate, zinc steel plate and tin plate.

(10) The process of producing a reflecting member for a surface light source according to the section (8) or (9) is characterized in that the white coating film has a film thickness of from 50 to 300 μm.

(11) The process of producing a reflecting member for a surface light source according to any one of the sections (8) to (10) is characterized in that in the molding of the metal part, a curved part is formed on the metal part.

(12) The process of producing a reflecting member for a surface light source according to the section (11) is characterized in that when the film thickness of the white coating film is A μm and the curvature radius of the curved part of the metal part is B mm, the value of A/B is not less than 10.

(13) The process of producing a reflecting member for a surface light source according to any one of the sections (8) to (12) is characterized in that the white coating film comprises a powder coating material.

(14) The process of producing a reflecting member for a surface light source according to any one of the sections (8) to (12) is characterized in that the white coating film comprises a liquid coating material.

(15) A reflection board for a liquid crystal backlight obtainable by using a reflecting member for a surface light source as claimed in any one of the sections (1) to (7).

(16) A liquid crystal backlight unit obtainable by using a reflection board for a liquid crystal backlight as claimed in the section (15).

### BRIEF DESCRIPTION OF DRAWING

FIG. 1 shows a molded article prepared in Examples.

FIG. 2 shows a reflecting member for a surface light source prepared in Examples.

FIGS. 3(a), (b) and (c) are schematic diagrams showing shapes of direct type backlight system reflection boards.

### DESCRIPTION OF CODE

10 . . . Molded article
12 . . . Metal part
14 . . . Convex part
16 . . . Concave part
20 . . . Reflecting member for a surface light source
22 . . . Coated film
102 . . . Cold-cathode tube
104, 110 . . . Curved part
106, 112, 120 . . . Reflection board

### BEST MODE FOR CARRYING OUT THE INVENTION

The reflecting member for a surface light source, the production process of the reflecting member and the use thereof according to the present invention will be described in detail hereinafter.

The reflecting member for a surface light source according to the present invention is obtainable forming a white coating film on the surface of a molded metal part having a prescribed shape. The reflecting member for a surface light source prepared even if by using a metal part having a curved part of a small curvature radius can attain sufficient reflecting properties.

Firstly, molding of the metal part is described.

<Molding of Metal Part>

The molding of the metal part is not particularly limited as far as the metal part can be molded into a predetermined reflecting member shape for a surface light source, and can be carried out by conventionally known methods. Examples of the molding methods may include a bending molding method, a deep drawing method and other methods. Specific examples of the bending method may include V-bending, U-bending, end bending, wave bending, tensile bending and other bending methods. Using these methods, the metal part is molded into a desired shape.

As the metal part, any raw material may be used as far as it can keep a prescribed shape in assembling it to a backlight unit. In the present invention, it is preferred to use an aluminum plate, aluminum alloy plate, iron plate, stainless steel part, copper plate, zinc steel plate, tin plate and the like from the view point of capable of molding by press molding for a short time. Of these plates, it is more preferred to use the aluminum plate or aluminum alloy plate because the plates can transmit heat generated in a backlight unit to the outside efficiently and can remove the heat. One kind or a combination of two or more kinds of these plates may be used as the metal part.

In the case of using the aluminum plate or aluminum alloy plate as the metal part, these plates may have strength capable of forming a backlight unit and keeping it. Further, in the case of using the aluminum alloy plate as the metal plate, any one of 1000, 2000, 3000, 4000, 5000 and 6000 series aluminum alloys can be used as far as it has sufficient molding properties in drawing molding and bending molding.

Among the aluminum plates and aluminum alloy plates, those having a thermal conductivity at 25° C. of not less than 190 W/m·K are preferred. Using the aluminum plate or the aluminum alloy plate as a support of the reflection board, thermal diffusion is conducted rapidly and heat radiation can be conducted in a wider surface. Therefore, it is possible to efficiently remove heat generated in the backlight unit to the outside.

The aluminum plate or aluminum alloy plate used desirably has a plate thickness of from 0.1 to 5 mm, preferably 0.2 to 3.0 mm. When the plate thickness is less than 0.1 mm, it has inferior strength, on the other hand, when it is over 5 mm, the molding properties thereof are lowered and also the weight thereof is increased and thereby the production cost thereof is increased. Therefore, it is not preferred as a thin display device to use the aluminum plate or aluminum alloy plate having a plate thickness of less than 0.1 mm or over 5 mm.

In coating such a metal part surface with a coating material, it is desirable to carry out surface treatment of the metal part previously in order to prevent cissing and enhance the adhesion properties of the coating material. The surface treatment may be carried out before or after molding the metal part.

This surface treatment can be carried out by a conventionally known method, for example, a surface roughening method such as treatment with paper, sand blasting treatment, shot blasting treatment, treatment with steal wool, brushing treatment or honing treatment; a degreasing method such as organic solvent degreasing method, surfactant degreasing method, sulfuric acid degreasing method, electrolytic degreasing method, alkali degreasing method, emulsification degreasing method or phosphate treatment; a chemically polishing method such as treatment with phosphoric acid-nitric acid, Kaiser method, Alupol I method or treatment with alkali-chromate, treatment with chromate, treatment with phosphoric acid-chromate, treatment with zinc phosphate; or a method of forming hydrated oxide coating.

Such a metal part is molded in the above-described manner, and then a coating material is applied on the surface of the metal part to form a white coating film.

The coating material is described below.

<Coating Material>

The coating material used in the present invention is not particularly limited and any coating material can be used as far as it can form a white coating film on the metal part surface.

The form of the coating material is not particularly limited and any of a powder type coating material (hereinafter referred to as a powder coating material) or a liquid type coating material (hereinafter referred to a liquid coating material) may be used.

In the present invention, it is preferred for application on the molded metal part to use the powder coating material, particularly it is preferred for application on the curved metal part molded to use the powder coating material. Because the powder coating material contains no solvent, a thick coating film having a thickness of about 100 μm can be uniformly formed on the metal part surface at once by using the powder coating material and coating can be conducted at one time until the film thickness reaches the thickness capable of securing a high reflectance. Also, the powder coating material is desirably used from the viewpoint of production cost.

Any powder coating material may be used without particularly limitation. Examples of the powder coating material may include an epoxy resin type powder coating material containing, as a curing agent, dicyane diamide, acid anhydride or dibasic acid dihydrazide; an epoxy-polyester resin type powder coating material containing, as a curing agent, an epoxy resin; a polyester resin type powder coating material containing, as a curing agent, block isocyanate and the like; and an acryl resin type powder coating material containing, as a curing agent, aliphatic dibasic acid and the like. These powder coating materials are disclosed in “Crosslinking agent Handbook” published by Taiseisha Co., Ltd, on Oct. 20, 1981, p. 276, Editor: YAMASHITA Shinzo and “The Finish & Paint” No. 558, p. 73 published on 1997.

In the meantime, any liquid coating material can be used without particular limitation. Examples of the liquid coating material may include an oil based coating material essentially containing dry oil, an alkyd resin type coating material, an amino alkyd resin type coating material essentially containing a mixture of a short-oil alkyd resin and an amino resin, a lacquer coating material prepared by dissolving a polyester resin in a solvent, a polyurethane resin type coating material essentially containing an isocyanate compound and a prepolymer having a plurality of hydroxyl groups, an epoxy resin type coating material, a baking polyester resin type coating material, a baking epoxy ester resin type coating material, a high temperature baking epoxy resin type coating material essentially containing an epoxy resin and a phenol resin or amino resin, an amine or polyamide curing epoxy resin type coating material, an acryl lacquer, a baking acryl resin type coating material, a curing coating material which comprises a (meth)acryl group-containing compound and/or an unsaturated polyester compound and/or other polymerizable unsaturated linkage-having compound, and a photo or thermal radical polymerization initiator as an initiator, a silicon resin type coating material and a fluororesin type coating material.

Of the above powder coating materials and liquid coating materials, the polyester resin type coating material and the hydroxyl group-containing acryl resin type coating material are preferred from the viewpoints of low absorption of visible rays, low initial coloration, adhesion properties and coating properties with metal parts, resistance to solvent popping in baking, light resistance and cost. The polyester resin preferably contains a hydroxyl group, and examples of the polyester resin containing a hydroxyl group may include an oil-free polyester resin, oil-modified alkyd resin or modified products of these resins, specifically, a urethane modified polyester resin, urethane modified alkyd resin, epoxy modified polyester resin and acryl modified polyester resin.

The polyester resin type coating material or the hydroxyl group-containing acryl resin type coating material preferably contains, as a curing agent, an amino resin, a polyisocyanate compound or a blocking polyisocyanate compound. These curing agents are described below.

(Curing Agent)

Examples of the amino resin may include methylol amino resins obtainable by reaction of aldehyde with an amino component such as melamine, urea, benzo-guanamine, aceto-guanamine, stero-guanamine, spiro-quanamine, dicyane diamide or the like.

Examples of the polyisocyanate compound may include aliphatic diisocyanates such as hexamethylene diisocyanate or trimethyl hexamethylene diisocyanate; cyclic aliphatic diisocyanates such as hydrogenated xylene diisocyanate or isophorone diisocyanate; aromatic diisocyanates such as tolylene diisocyanate or 4,4′-diphenyl methane diisocyanate; organic polyisocyanates, for example, polyisocyanate compounds having three or more isocyanate groups such as triphenyl methane-4,4′4″-triisocyanate, 1,3,5-triisocyanato benzene, 2,4,6-triisocyanato toluene, 4,4′-dimethyl diphenyl methane-2,2′,5,5′-tetraisocyanate; adducts of each of these organic polyisocyanates with a polyvalent alcohol, low molecular weight polyester resin or water; cyclic polymers of the above organic polyisocyanates; and isocyanate-biuret compounds.

Commercially available examples of these polyisocyanate compounds may include Sumidur T-80, Sumidur N-3200, Sumidur N-3300, Sumidur L, Desmodur H, Desmodur I and Desmodur I L (Product name, manufactured by Sumitomo Bayer Urethane Co., Ltd.), LTI (Product name, manufactured by Kyowa Hakko Chemical Co., Ltd.), Takenate D series (Product name, manufactured by Takeda Pharmaceutical Co., Ltd.), Coronate HX, Coronate 2092, Coronate HL and Coronate 2094 (Product name, manufactured by Nippon Polyurethane Industry Co., Ltd.), and Duranate 24A-100, Duranate 22A-75PX, Duranate 21S-75E, Duranate 18H-70B, Duranate TPA-100, Duranate THA-100, Duranate MFA-90X, Duranate TSA-100, Duranate TSS-100, Duranate TSE-100, Duranate p-301-75E, Duranate E-402-90T and Duranate E-405-80T (product name, manufactured by Asahi Kasei Corporation).

The blocking polyisocyanate compound used as the curing agent is a compound prepared by blocking a free isocyanate group of the above polyisocyanate compound with a blocking agent and it is preferably used for the case where the storage stability of a coating material is required after mixing thereof.

Examples of the blocking agent for blocking isocyanate group preferably used in the present invention may include phenol type blocking agents such as phenol, cresol and xylenol; lactam type blocking agents such as ε-caprolactam, δ-valerolactam, γ-butyrolactam and β-propiolactam; alcohol blocking agents such as methanol, ethanol, n- or i-propyl alcohol, n-, i- or t-butyl alcohol, ethylene glycol monomethyl ether, ethylene glycol monoethyl ether, ethylene glycol monobutyl ether, diethylene glycol monomethyl ether, diethylene glycol monoethyl ether, propylene glycol monomethyl ether and benzyl alchol; oxime type blocking agents such as formamide oxime, acetaldoxime, acetoxime, methylethyl ketoxime, diacetyl monoxime, benzophenone oxime and cyclohexane oxime; and active methylene type blocking agents such as dimethyl malonate, diethyl malonate, ethyl acetoacetate, methyl acetoacetate and acetyl acetone. Mixing the above polyisocyanate compound and the above blocking agent can easily block a free isocyanate group of the polyisocyanate compound.

Commercially available examples of the blocking polyisocyanate compound may include Takenate B series (Product name, manufactured by Takeda Pharmaceutical Co., Ltd.), Coronate AP Stable, Coronate 2503, Coronate 2507, Coronate 2527 (Product name, manufactured by Nippon Polyurethane IndustryCo., Ltd) and Sumidur BL3175, Sumidur BL 4265, Sumidur AP Stable, Sumidur CT Stable, Sumidur BL 1100 (Product name, manufactured by Sumitomo Bayer Urethane Co., Ltd.).

In order to enhance the curing properties of the coating material, curing catalysts as described below can be simultaneously used.

(Curing Catalyst)

In the case that the curing agent is an amino resin, examples of the curing catalyst may include strong acids and neutralized products of strong acids. Specific examples thereof may include sulfonic acid compounds, which are highly acidic compounds such as p-toluene sulfonic acid, dodecyl benzene sulfonic acid, dinonyl naphthalene sulfonic acid and dinonyl naphthalene disulfonic acid, and amine neutralized products of these sulfonic acid compounds.

In the case that the curing agent is a blocking polyisocyanate compound, a curing catalyst capable of accelerating dissociation of the blocking agent of the blocking polyisocyanate compound, which is a curing agent, is used. Examples of the curing catalyst may include organometal catalysts such as tin octoate, dibutyl tin di(2-ethyl hexanoate), dioctyl tin di(2-ethyl hexanoate), dibutyl tin dilaurate, dibutyl tin oxide, dioctyl tin oxide, lead 2-ethyl hexanoate.

In the case that the curing agent is a polyisocyanate compound, examples of the curing catalyst may include organometal catalysts such as tin octoate, dibutyl tin di(2-ethyl hexanoate), dioctyl tin di(2-ethyl hexanoate), dibutyl tin dilaurate, dibutyl tin oxide, dioctyl tin oxide and lead 2-ethyl hexanoate.

(Titanium Oxide Pigment)

The coating material of the present invention contains a titanium oxide pigment as an essential component. The production process, the surface treatment and the kind of the titanium oxide pigment are not particularly limited. It is preferred to use a titanium oxide pigment having hiding properties as high as possible and high degree of whiteness. Particularly, it is preferred to use a rutile-type titanium oxide coated with at least one surface treating agent selected from alumina, silica, titania and zirconia and having an average particle diameter of from 0.2 to 0.3 μm. The coated rutile-type titanium oxide shows high light resistance and has excellent hiding properties for substrate.

Commercially available examples of the titanium oxide pigment may include Ti-PURE-R706 and Ti-Pure-R960 (Product name, manufactured by Du Pont Co., Ltd.), TIPAQUE CR-50, TIPAQUE CR-60, TIPAQUE CR-90, TIPAQUE CR-95 and TIPAQUE CR-97 (Product name, manufactured by Ishihara Sangyo Kaisha Ltd.), and CR 888 (Product name, manufactured by Kerr-McGee Corporation.).

The titanium oxide pigment is contained in the coating material in an amount of from 50 to 1000 parts by weight, preferably 50 to 500 parts by weight based on 100 parts by weight of the resin components. When the amount of the titanium oxide pigment is less than 50 parts by weight, the hiding properties for substrate is insufficient and the reflectance is inferior as the reflecting member for a surface light source. As a result, the brightness of a liquid crystal display screen is lowered. On the other hand, when it is over 1000 parts by weight, the improvement of the reflectance is not desired and in preparing the coating material, the coating material viscosity is increased and thereby it is difficult to conduct mixing or the pigment is not dispersed fully with the result that the insoluble pigment is remained.

(Other Additives)

Furthermore, to the coating material used in the present invention, white particles, a fluorescent pigment, an UV absorbing agent and a light stabilizer may be added.

(White Particles)

Examples of the white particles may include calcium carbonate, magnesium carbonate, zinc carbonate, zinc oxide, barium sulfate, magnesium oxide, calcium phosphate, silica, alumina, mica, talc, kaolin, organic fine particles, organic hollow fine particles and hollow glass bead.

Commercially available examples of the organic fine particles used herein may include TechPolymer MBX series, Tch Polymer SBX series and TechPolymer MB series (product name, manufactured by Sekisui Plastics Co., Ltd.) and Chemisnow MX series, Chemisnow MR series, Chemisnow SX series (product name, manufactured by Soken Chemical & Engineering Co., Ltd.).

Commercially available examples of the organic hollow fine particles used herein may include SX866(A) (product name, manufactured by JSR Corporation.), Ganz pearl GMH-0850 (product name, manufactured by Ganz Chemical Co., Ltd.) and EXPANCEL (product name, Nihon Filite Co., Ltd.).

Commercially available examples of the hollow glass bead used herein may include Scotchlite, glass bubbles K, S series (product name, manufactured by Sumitomo 3M Co., Ltd.), Fuji Balloon H, S series (product name, Fuji Silysia Chemical Ltd.) and HSC-110 (product name, Potters-Ballotini Ltd.)

These white fine particles may be used singly or in combination with two or more kinds. The particle diameter is not particularly limited and is generally from 0. 05 to 50 μm, preferably 0.1 to 40 μm, more preferably 0.1 to 30 μm. When the particle diameter is less than 0.05 μm, the hiding properties for substrate are low, and the coloring power is insufficient, while, it is over 50 μm unfavorably, because the coating surface is roughened in an extent over the necessity.

(Fluorescent Pigment)

In the ultraviolet ray, the ultraviolet ray part having a wavelength of from 300 to 400 nm is liberated from a cold-cathode tube, but cannot be observed visually. On this account, the ultraviolet ray part having a wavelength of from 300 to 400 nm has not been effectively used for improving the brightness. The fluorescent pigment has an effect of improving the brightness of backlight by making the ultraviolet ray part having a wavelength of from 300 to 400 nm into a visible fluorescent ray having a wavelength of about from 400 to 450 nm.

However, when the amount of this fluorescent pigment added is large, the light resistance of the coating film is easily lowered. Therefore, the fluorescent pigment is desirably added in an amount of from 0.001 to 3% by weight, preferably 0.005 to 1% by weight, more preferably 0.01 to 0.5% by weight based on 100 parts by weight of the resin components (sic % by weight). When the added amount is less than 0.001 % by weight, the effect of improving the brightness is low, while it is unfavorably over 3% by weight because the coating film becomes yellowish.

Commercially available examples of the fluorescent pigment may include LUVITEX OB and LUVITEX MD (product name, manufactured by Ciba Specialty Chemicals Co., Ltd.), OB-1 (product name, manufactured by Eastman Chemical Japan Ltd.) and SIGENOX (product name, manufactured by Hakkol Chemical Co., Ltd.).

(UV Absorber and Light Stabilizer)

To the coating material of the present invention, an UV absorber and a light stabilizer which are generally used in coating materials can be appropriately used to secure the coating properties and the light resistance.

Examples of the UV absorber may include benzophenone type, benzotriazole type, triazine type, cyanoacrylate type, salicylic acid type, benzoate type, oxalic anilide type and sol or gel inorganic absorbers. Further it is preferred to use copolymerized absorbers of these UV absorbers.

As the light stabilizer, conventionally known light stabilizers typified by hindered amine type light stabilizers can be used.

Furthermore, various additives can be appropriately added to the coating material without marring the effect of the present invention. Examples of such additives are a heat stabilizer, oxidation stabilizer, organic lubricant, fluid regulator and adhesion imparting agent such as silane-coupling agent and the like. Examples of the silane-coupling agent used may include KBM 303, KBM 403 and KBM 402 (product name, manufactured by Shin-Etsu Chemical Co., Ltd.).

In accordance with necessity, it is possible to use conventionally known additives, for example, silicon type, fluorine type or polymer type antifoaming agents; leveling agent; silicon type or acryl type pigment dispersing agents; flame retardants such as nitrogen containing compounds and the like including antimony trioxide, bromine compound, phosphate, red phosphorus and melamine resin; and stress relaxing agents such as silicon oil or powdery silicon rubber.

When the liquid coating material is used as the white coating material, a solvent may optionally be blended with the liquid coating material, and thereby the viscosity can be regulated in accordance with the coating method and a smooth coating film can be prepared.

It is possible as the solvent to use solvents capable of dissolving or dispersing the above resin components for forming coating films. Examples of the solvents may include hydrocarbon solvents such as toluene, xylene and petroleum type hydrocarbons having high boiling point; ketone solvents such as methyl ethyl ketone, methyl isobutyl ketone, cyclohexanone and isophorone; ester type solvents such as ethyl acetate, butyl acetate, ethylene glycol monoethyl ether acetate and diethylene glycol monoethyl ether acetate; alcohol type solvents such as methanol, ethanol and butanol; ether alcohol type solvents such as ethylene glycol monoethyl ether, ethylene glycol monobutyl ether, diethylene glycol monobutyl ether. These solvents may be used singly or in combination with two or more.

Using these materials, the powder coating material and the liquid coating material are prepared in the following manners.

(Process for Preparing Coating Materials)

For preparing the powder coating material, firstly, the resin, the pigment, the additives and the like are mixed by a Henschel mixer and thereafter the mixture is molten and kneaded by a co-kneader heated at a temperature of from 80 to 150° C., and subsequently cooled and the pulverized to prepare a pelletized kneadate. The pelletized kneadate is pulverized to have an average particle diameter of about 20 to 40 μm by a pin mill and the powder coating material is prepared.

For preparing the liquid coating material, the raw materials, for example, the resin, the pigment, the white particles, the additives and the organic solvent are mixed by a conventionally known mixing apparatus. The mixing apparatus is not particularly limited as far as the materials can be mixed homogenously. Examples of the mixing apparatus may include a stirrer equipped with a stirring blade, a stirring kneader, a paint shaker, a kneader, a triple roll mill and the like. The mixing apparatus is selected taking the viscosity of the composition into consideration

Using the coating materials thus prepared, the reflective member for a surface light source according to the present invention is prepared.

<Process for Preparing Reflective Member for a Surface Light Source>

The reflective member for a surface light source according to the present invention is prepared by applying the coating material on the surface of the molded metal part having a prescribed shape and curing, and thereby forming a white coating film.

In the case of using the powder coating material, the coating is generally carried out by an electrostatic spray coating method. After the coating, the coating film is generally cured with heating at a temperature of from 130 to 220° C. for 3 to 30 min. The coating with the powder coating material can form a coating film having a thickness of 100 μm at one time even if the metal part has a complicated uneven shape. The coating with the powder coating material is preferred because it has no problems such that the film thickness of the convex part of the coating film is thin or the concave part thereof is filled with the coating material.

The liquid coating material is applied by a immersing coating method, a spray coating method, a brushing coating method and the like. When a coating film having a thickness of 50 μm or thicker cannot be formed using the liquid coating material at one time because of occurrence of solvent popping, the coating can be conducted by two or more times. After the coating with the liquid coating material, the solvent is removed from the coating film by heating at a temperature of about from 25 to 100° C. for 10 sec to 30 min, and then the coating film is cured by thermosetting, a method of using an active ray such as heat ray, ultraviolet ray, electron beam, radiation, etc or a combined method thereof. In the method of using an heat ray, the coating film is cured by heating at a temperature of from 80 to 230° C. for 1 to 120 min.

Furthermore, in any coating method, coating may be carried out by separately coating two layers of an under coating layer and a top coating layer which layers have different functions each other. For example, a resin type coating material having good adhesion properties to a base material is selected as the under coating layer, and a resin type coating material capable of meeting the need to coating film properties such as light resistance and hardness can be selected as the top coating layer. Additionally, the delustering agent, fluorescent brightening agent, UV absorbent and light stabilizer can be added to the top coating layer only.

When the reflecting member laminated with plural coating films is prepared using the liquid coating material, the top layer may be coated after coating the under coating layer and drying (before curing). However, in order to attain the effect of lamination, it is necessary to not mingle the components of the layers joined each other. Therefore, it is desired to coat the top layer after semi-curing or completely curing the under coating layer.

The reflecting member for a surface light source thus prepared according to the present invention has high hiding properties to the coating film and further has such a property that the higher the degree of whiteness of the reflecting member is, the higher the reflectance thereof is. Therefore, it is advantageous that the white coating film formed is thicker. Accordingly, the coating film has a dried thickness of desirably from 50 to 300 μm, preferably 70 to 180 μm. When the thickness thereof is less than 50 μm, the prescribed reflectance (the total reflectance at a wavelength of 550 nm; not lower than 85%) cannot be obtained. Even when the thickness is over 300 μm, the reflectance is not enhanced and further the weight of the resulting reflecting member is large. It is not preferable from the viewpoint of costs.

The reflecting member for a surface light source thus prepared according to the present invention is used as a light source reflection board such as reflection boards for backlight of liquid crystal display and the like so that it has a total reflectance at a wavelength of 550 nm of preferably not less than 85%, more preferably not less than 87%, particularly preferably not less than 90%. When the reflectance is less than 85%, liquid crystal displays with the reflecting member sometimes are insufficient in brightness. The reflecting member for a surface light source according to the present invention thus prepared has excellent initial brightness and low deterioration even after long time use so that it can maintain the brightness of liquid crystal display screen. The total reflectance is a value determined by a reflectance spectrophatometer.

For obtaining the total reflectance of not less than 85% as described above, the film thickness is required to be not less than 50 μm. However, when various chassis structures are formed by press molding etc after coating the metal part, the coating film is thin in the convex part (mountain fold) and thereby cracks are easily induced, or the coating film is thick in the concave part (valley fold), with the result that uniform reflectance cannot be obtained.

According to the present invention, the metal part is molded and then the white coating film is formed on the surface of the metal part and thereby the reflecting member for a surface light source capable of preparing an uniform reflectance and sufficient reflecting properties can be prepared.

The reflecting member of a surface light source of the present invention has a ratio of A/B of not less than 10, preferably not less than 50 wherein the film thickness of the white coating film is A μm and the curvature radius of the curved part of the metal part surface is B mm. If the base material can be processed, the curvature radius may be small. As is described above, even if the metal part has small curved parts (convex part and concave part) having a small curvature radius, the reflecting member for a surface light source having sufficient reflecting properties can be prepared.

In the reflecting member for a surface light source, the white coating film has a glossiness of from 5 to 50, preferably 10 to 40. The white coating film has a low glossiness as described above so that the diffuse reflectance is high and when the reflecting member is assembled as a reflection board for liquid crystal displays, the unevenness of the brightness is low. The glossiness is a relative-specular surface glossiness at 60 degree measured based on JISK-5400 7.6(1990). The glossiness of the reflecting member for a surface light source is regulated by determination of the kind, particle diameter or amount of the fine particles added to the coating material. Furthermore, the glossiness regulation can be also carried out with conventionally known delustering agents such as silica and the like in accordance with necessity.

Such a reflecting member for a surface light source of the present invention can be used as a reflection board for liquid crystal backlight and further, it can provide a liquid crystal backlight unit prepared by using this reflection board for liquid crystal backlight.

The liquid crystal backlight, which is not particularly limited, has a fluorescent tube provided the back of a liquid crystal panel, the reflection board of the present invention capable of holding the fluorescent tube and reflecting light emitted from the fluorescent tube to the liquid crystal panel side, and a power supply circuit part capable of driving the fluorescent tube basically.

### EFFECT OF THE INVENTION

According to the present invention, a reflecting member for a surface light source wherein a white coating film having sufficient reflecting properties is formed on a metal part even if a metal part having a curved part of a small curvature radius can be provided.

### EXAMPLE

The present invention is described in more detail with reference to the following examples and comparative examples below. The terms “part” and “%” are on the basis of weight. The following commercially available materials were used as raw materials.

| | |
|---|---|
| Epikote 1004: | manufactured by Yuka Shell Epoxy Co., Ltd. |
| | Epoxy resin |
| GV-150: | manufactured by Japan U-PiCA Co., Ltd. |
| | Polyester resin |
| GV-230: | manufactured by Japan U-PiCA Co., Ltd. |
| | Polyester resin |
| Epikote 1003F: | manufactured by Yuka Shell Epoxy Co., Ltd. |
| | Epoxy resin |
| DesmopheneA575: | manufactured by Sumitomo Bayer Urethane Co., |
| | Ltd. Acrylpolyol, Solid component 75% |
| Desmophene670BA: | manufactured by Sumitomo Bayer Urethane Co., |
| | Ltd. Polyester polyol, Solid component 80% |
| Bekkolite | manufactured by Dainippon Ink & Chemicals, |
| M-6402-50: | Inc. Oil free alkyd resin, Solid component |
| | 50% |
| Duranate TSE-100 | manufactured by Asahi Kasei Co., non |
| | yellowed polyisocyanate |
| Sumidur BL3175 | manufactured by Sumitomo Bayer Urethane Co., |
| | Ltd., Block isocyanate, Solid component 75% |
| Super Bekkamin | manufactured by Dainippon Ink & Chemicals, |
| L-109-65 | Inc., butylated melamine resin, Solid |
| | component 60% |
| CR-90 | manufactured by Ishihara Sangyo Kaisha Ltd. |
| | titanium oxide prepared by chlorine method, |
| | average particle diameter 0.25 μm |
| MR-7G | manufactured by Soken Chemical & Engineering |
| | Co., Ltd. crosslinked acryl particles, |
| | average primary particle diameter 5.0 μm |
| Sylosphere | manufactured by Fuji Silysia Chemical Ltd. |
| C-1504 | spherical fine powdery silica, average |
| | particle diameter 4.5 μm |
| PF-S | manufactured by Kyoueisha Oil and Fat Co., |
| | Ltd. Fluidity regurator |
| Luvitex OB | manufactured by Ciba Specialty Chemicals |
| | Co., Ltd. Fluorescent brightening agent |
| Tinuvin 329FL | manufactured by Ciba Specialty Chemicals |
| | Co., Ltd. Ultraviolet ray absorbent |
| Sanol LS770 | manufactured by Sankyo Co., Ltd. Hindered |
| | amine type light stabilizer |
| BYK-354 | manufactured by BYK-Chemie GmbH. Acryl type |
| | wetting and dispersing agent |

### Examples 1 to 8

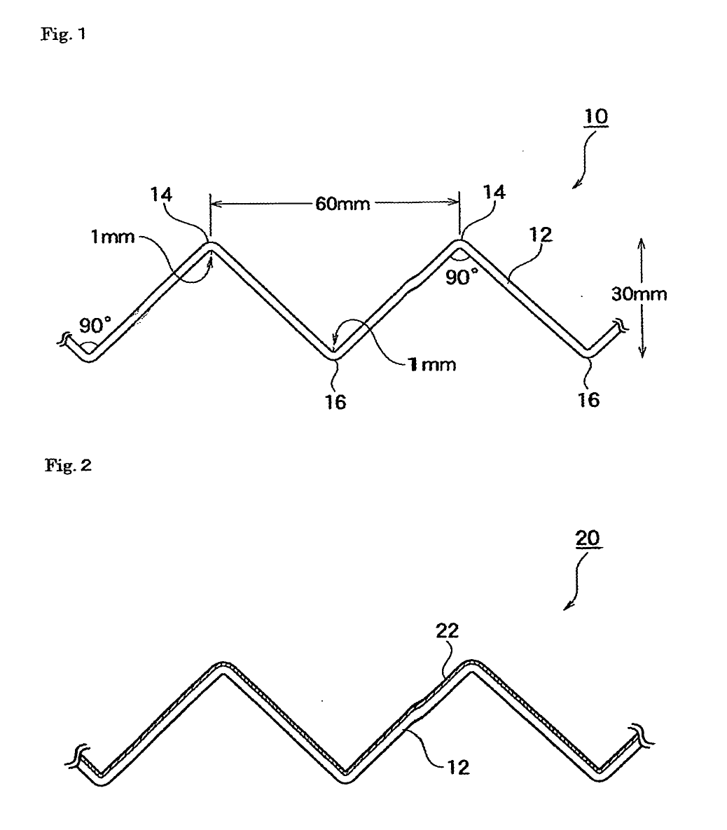

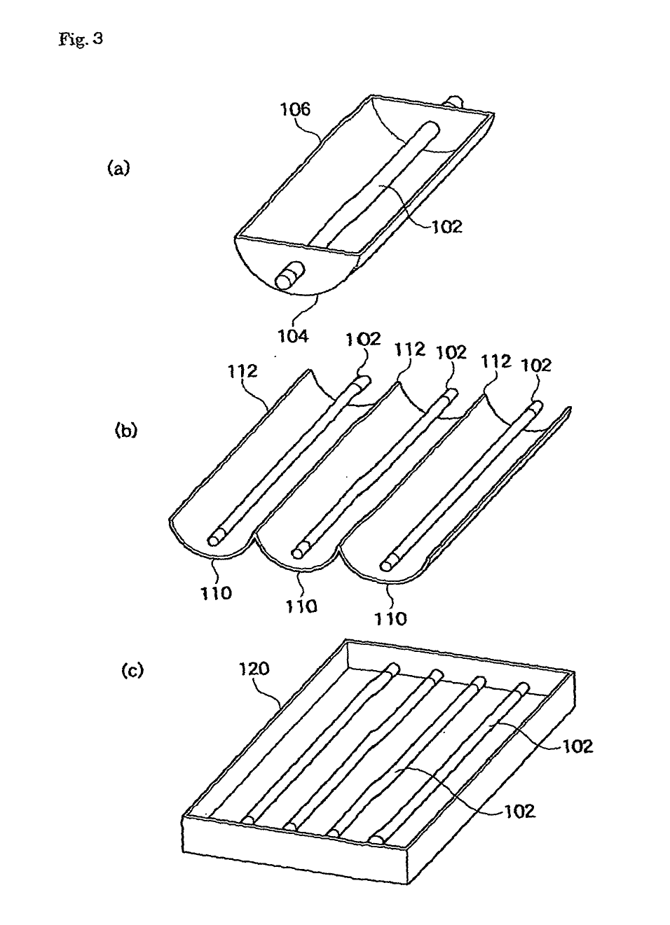

In each of Examples 1 to 8, a coating material was prepared in accordance with the blending as shown in Table 1. As a metal part for a surface light source, an aluminum alloy plate 5052-H32 having a width of 300 mm×a length of 100 mm×a thickness of 0.4 mm was used, and this aluminum alloy plate was subjected to bending processing by bending at 90 degree turn about and thereby molded into a wave form having a curvature radius of 1.0 mm. As shown in FIG. 1, on a metal part 12 of a molded article 10, convex parts 14 were horizontally formed at intervals of 60 mm and between the neighboring convex parts 14, the concave parts 16 were formed. The convex part and concave part each had a curvature radius of 1.0 mm. The molded article was treated with chromate-phosphate and coated to have a film thickness of 100 μm in such a manner that in each of Examples 1 to 3, a powder coating material as shown in Table 1-1 was applied by electrostatic spray coating and in each of Examples 4 to 8, a liquid coating material as shown in Table 1-2 was applied by spray coating. The coated article was baked at a temperature for a curing time as described in Table 1 to prepare a reflecting member 20 for a surface light source in which a coating film 22 was formed on the surface of the metal part 12 as shown in Table 1-2. The resulting reflecting member for a surface light source was used as a testing board and the coating film property test thereof was carried out by the following test methods. The results are shown in Table 1.

Further, the procedure of Example 1 was repeated using an aluminum alloy plate 5052-H32 having a width of 300 mm×a length of 100 mm×a thickness of 0.4 mm except that the film thickness of a coating film formed on the surface of the alloy plate, to prepare a reflecting member for a surface light source. The relation between the film thickness and the total reflectance is shown in Table 2.

Furthermore, the reflecting member for a surface light source used in measuring the relation between the film thickness and the total reflectance was subjected to bending processing with a curvature radius of 1.0 mm in the same manner as Example 1. The relation between the coating film thickness and occurrence of cracks in bending is shown in Table 3.

<Testing Methods>

1) Coating Film Appearance:

The coating film appearance of a testing coated board was visually evaluated in accordance with the following standards.
Good: Solvent popping, cissing, cratering and other problems were not observed on the coated surface.
Fair: Solvent popping, cissing, cratering and other problems were slightly observed on the coated surface.
Not Good: Solvent popping, cissing, cratering and other problems were observed much on the coated surface.
   2) Glossiness:

In accordance with the relative-specular glossiness at 60 degree as determined JISK-5400 7.6 (1990), the reflectance each at a light incidence angle of 60 degree and a light intercepting agent of 60 degree was measured and based on the relative-specular glossiness of the standard black mirror surface being 90, the measuring value was determined.

3) Film Thickness:

The film thickness was measured using a Coating thickness tester LZ-900 manufactured by Kett Electric Laboratory Co., Ltd.

4) Total Reflectance:

The reflectance at a wavelength of 550 nm was measured by a spectrophotometer UV-2400PC (integrating sphere ISR-2200) manufactured by Shimazu Corporation and expressed by percentage based on 100 of the reflectance of a MgO white plate.

5) Adhesion Properties:

In accordance with a cross cut tape method defined in JIS K-5400 8.5.2 (1990), 11 parallel straight lines were drawn with a distance of 1 mm and further 11 parallel straight lines were orthogonally drawn with a distance of 1 mm using a cutter knife on the coated film surface of a testing board in such a way that the cutter knife reached to the base material, and thereby 100 squares having a size of 1 mm×1 mm was prepared. On the surface, a cellophane adhesive tape was adhered and the tape was peeled rapidly. In this test, the degree of the peeled squares was observed and evaluated by the following standards.
Good: Peeling of the coated film was not observed at all.
Fair: The coated film was slightly peeled, and the number of the remained squares was not less than 90.
No good: The coated film was considerably peeled and the number of the remained squares was less than 90.
   6) Light Resistance:

Light irradiation was conducted for 240 hr using ATLAS Weather-O meter Ci4000 (Intensity of irradiation: 0.55 W/m², Humidity: 50%, Black panel temperature: 35° C., Boronsilicate glass+Soda lime glass filter was used) and then the degree of yellowness was visually evaluated on the basis of the following standards.
Good: Yellowing was not observed.
Fair: Yellowing was slightly observed.

No good: Yellowing was markedly observed.

TABLE 1

| (part by weight) | | Example 1 | Example 2 | Example 3 |
|---|---|---|---|---|
| Resin | Epikote | 60 | 86 | |
| | 1004 | | | |
| | GV-150 | | | |
| | GV-230 | | | 58 |
| Curing | Dicyane | 2 | | |
| agent | diamide | | | |
| | B1530 | | 14 | |
| | Epikote | | | 42 |
| | 1003F | | | |
| Pigment | CR-90 | 50 | 50 | 50 |
| | MR-7G | | 5 | |
| Curing | Dibutyl tin | | 0.3 | |
| catalyst | dilaurate | | | |
| | Imidazole | | | 0.2 |
| Fluidity | PF-S | 0.2 | 0.2 | 0.2 |
| regulator | | | | |
| Delustering | Sylosphere | 2 | 3 | |
| agent | C-1504 | | | |
| Fluorescent | Luvitex OB | | | 0.1 |
| brightening | | | | |
| agent | | | | |
| Ultraviolet | Tinuvin | 0.3 | 0.3 | 0.3 |
| ray | 329FL | | | |
| absorber | | | | |
| Light | Sanol LS770 | 0.3 | 0.3 | 0.3 |
| stabilizer | | | | |

| | | | |
|---|---|---|---|
| Curing temperature (° C.) | 180 | 180 | 170 |
| Curing time (min) | 20 | 20 | 20 |
| Film thickness (μm) | 103 | 110 | 107 |
| Coating film appearance | good | good | good |
| Glossiness | 25 | 30 | 75 |
| Total reflectance | 94 | 93 | 91 |
| (wavelength: 550 nm) | | | |
| Adhesion properties | good | good | good |
| Light resistance | good | good | good |

| | | Example | | | | |
|---|---|---|---|---|---|---|
| (part by weight) | | 4 | 5 | 6 | 7 | 8 |
| Resin | Desmophene | 25 | 25 | | | |
| | A575 | | | | | |
| | Desmophene | | | 25 | 25 | |
| | 670 | | | | | |
| | Bekkolite | | | | | 100 |
| | M-6402-50 | | | | | |
| Curing | Duranate | 12 | | 15 | 15 | |
| agent | TSE-100 | | | | | |
| | Desmodur | | 17 | | | |
| | BL3175 | | | | | |
| | Super | | | | | 25 |
| | Bekkamin | | | | | |
| | L-109-65 | | | | | |
| Pigment | CR-90 | 62 | 62 | 65 | 71 | 133 |
| | MR-7G | | | 10 | | |
| Dispersant | BYK-354 | 0.4 | 0.4 | 0.4 | 0.4 | 0.4 |
| Delustering | Sylosphere | 1 | 1 | 1 | 1 | 3 |
| agent | C-1504 | | | | | |
| Fluorescent | Luvitex OB | | 0.1 | | | |
| brightening | | | | | | |
| agent | | | | | | |
| Ultraviolet | Tinuvin | 0.3 | 0.3 | 0.3 | 0.3 | 0.3 |
| ray | 329FL | | | | | |
| absorber | | | | | | |
| Light | Sanol | 0.3 | 0.3 | 0.3 | 0.3 | 0.3 |
| stabilizer | LS770 | | | | | |
| Solvent | Toluene | 17.2 | 17.2 | 19.0 | 19.0 | |
| | PEGMEA | 7.4 | 7.4 | 8.0 | 8.0 | |

| | | | | | |
|---|---|---|---|---|---|
| Curing temperature (° C.) | 100 | 150 | 100 | 100 | 150 |
| Curing time (min) | 120 | 120 | 120 | 120 | 30 |
| Film thickness (μm) | 98 | 107 | 97 | 98 | 100 |
| Coating film appearance | good | good | good | good | good |
| Glossiness | 20 | 18 | 22 | 25 | 30 |
| Total reflectance | 92 | 93 | 91 | 92 | 91 |
| (wavelength: 550 nm) | | | | | |
| Adhesion properties | good | good | good | good | good |
| Light resistance | good | good | good | good | good |

TABLE 2

| Film thickness (μm) | Total reflectance |
|---|---|
| 20 | 78 |
| 35 | 82 |
| 50 | 85 |
| 75 | 91 |
| 100 | 94 |
| 125 | 95 |

[image] TABLE 3

| Film thickness (μm) | Crack occurrence |
|---|---|
| 20 | Non-Occurrence |
| 35 | Non-Occurrence |
| 50 | occurrence |
| 75 | occurrence |
| 100 | occurrence |
| 125 | occurrence |

### Comparative Example 1

The coating and baking procedures of Example 1 was repeated using the coating material used in Example 1 and the aluminum alloy plate 5052-H32 having a width of 300 mm×a length of 100 mm×a thickness of 0.4 mm, to prepare a plate with a coated film having a film thickness of 100 mm. This coated film having plate was molded in the same manner as in Example 1. The convex surface of the coated film was cracked and thereby the aluminum alloy plate was exposed.

### Comparative Example 2

The coating and baking procedures of Example 1 was repeated using the coating material used in Example 4 and the aluminum alloy plate 5052-H32 having a width of 300 mm×a length of 100 mm×a thickness of 0.4 mm, to prepare a plate with a coated film having a film thickness of 105 mm. This coated film having plate was molded in the same manner as in Example 1. The convex surface of the coated film was cracked and thereby the aluminum alloy plate was exposed.

As is clear from the above, when the aluminum alloy plate was molded after the surface thereof was coated, the resulting coated film was cracked or peeled off. In result, the metal part surface was exposed and thereby uniform reflecting properties of the film are not obtained. Further, it is considered that even if the resulting film has no problem in appearance, the reflectance of the coated film part stretched at the time of molding is changed as compared with the flat part of the coated film. However, in the present invention, the coating is applied after the molding, and thereby these problems can be solved and a reflecting member for a surface light source wherein a white coating film having uniform reflecting properties and sufficient reflectance is formed can be prepared.

1. A reflecting member for a surface light source obtainable by forming a white coating film on the surface of a molded metal part having a prescribed shape.

2. The reflecting member for a surface light source according to claim 1 wherein the metal part comprises at least one selected from an aluminum plate, aluminum alloy plate, iron plate, stainless steel plate, copper plate, zinc steel plate and tin plate.

3. The reflecting member for a surface light source according to claim 1 wherein the white coating film has a thickness of from 50 to 300 μm.

4. The reflecting member for a surface light source according to claim 1 wherein in the molding of the metal part, a curved part is formed on the metal part.

5. The reflecting member for a surface light source according to claim 4 wherein when the film thickness of the white coating film is A μm and the curvature radius of the curved part of the metal part is B mm, the value of A/B is not less than 10.

6. The reflecting member for a surface light source according to claim 1 wherein the white coating film comprises a powder coating material.

7. The reflecting member for a surface light source according to claim 1 wherein the white coating film comprises a liquid coating material.

8. A process of producing a reflecting member for a surface light source which process comprises the steps of molding a metal part into a prescribed shape and then forming a white coating film on the surface of the metal part.

9. The process of producing a reflecting member for a surface light source according to claim 8 wherein the metal part comprises at least one selected from an aluminum plate, aluminum alloy plate, iron plate, stainless steel plate, copper plate, zinc steel plate and tin plate.

10. The process of producing a reflecting member for a surface light source according to claim 8 wherein the white coating film has a film thickness of from 50 to 300 μm.

11. The process of producing a reflecting member for a surface light source according to claim 8 wherein in the molding of the metal part, a curved part is formed on the metal part.

12. The process of producing a reflecting member for a surface light source according to claim 11 wherein when the film thickness of the white coating film is A μm and the curvature radius of the curved part of the metal part is B mm, the value of A/B is not less than 10.

13. The process of producing a reflecting member for a surface light source according to claim 8 wherein the white coating film comprises a powder coating material.

14. The process of producing a reflecting member for a surface light source according to claim 8 wherein the white coating film comprises a liquid coating material.

15. A reflection board for a liquid crystal backlight obtainable by using a reflecting member for a surface light source as claimed in claim 1.

16. A liquid crystal backlight unit obtainable by using a reflection board for a liquid crystal backlight as claimed in claim 15.
